(19) United States
(12) Patent Application Publication
(10) Pub. No.: US 2004/0230489 A1
(43) Pub. Date: Nov. 18, 2004

(54) System and method for mobile payment and fulfillment of digital goods

(76) Inventors: Scott Goldthwaite, Hingham, MA (US); William Graylin, Woburn, MA (US)

Correspondence Address: AKC PATENTS, 215 GROVE ST., NEWTON, MA, 02466, US

(21) Appl. No.: 10/729,043

(22) Filed: Dec. 5, 2003

Related U.S. Application Data
(63) Continuation-in-part of application No. 10/205,768, filed on Jul. 26, 2002.
(63) Continuation-in-part of application No. 10/625,823, filed on Jul. 23, 2003.
(63) Continuation-in-part of application No. 10/695,585, filed on Oct. 28, 2003.
(60) Provisional application No. 60/431,567, filed on Dec. 6, 2002.

(51) Int. Cl. G06F 17/60

(52) U.S. Cl. 705/26

(57) ABSTRACT

An electronic payment and fulfillment system utilized by a customer for purchasing a digital good includes a merchant server, a payment server, an authentication server, a fulfillment server and a communication device. The merchant server receives a purchase order from the customer and creates a digital order comprising purchase order information. The payment server receives the digital order from the merchant server and further routes the digital order. The authentication server receives the digital order from the payment server, formats the digital order into a first message and further routes the first message. The communication device includes a payment card module and the payment card module receives a payment card and reads payment card identification information stored in the payment card. The communication device also receives the first message from the authentication server, displays the first message to the customer, requests and receives authorization for payment for the purchase order with the payment card from the customer, retrieves the payment card identification information, requests and receives payment card security information from the customer, and routes the authorization and the payment card identification and security information to the authentication server. The authentication server further routes the authorization and payment card identification and security information to the payment server and from the payment server to a financial institution. The financial institution executes the payment and sends a payment confirmation through the payment server to the merchant server and to a fulfillment server. The fulfillment server transmits the digital good via the authentication server to the communication device, and the communication device stores the digital good onto the payment card.

### CROSS REFERENCE TO RELATED CO-PENDING APPLICATIONS

This application claims the benefit of U.S. provisional application Ser. No. 60/431,567 filed on Dec. 6, 2002 and entitled SYSTEM AND METHOD FOR MOBILE PAYMENT AND FULFILLMENT OF DIGITAL GOODS which is commonly assigned and the contents of which are expressly incorporated herein by reference.

This application is also a continuation in part of U.S. applications Ser. Nos. 10/205,768, 10/625,823, and 10/695,585, filed on Jul. 26, 2002, Jul. 23, 2003, and Oct. 28, 2003, and entitled “SYSTEM AND METHOD FOR PAYMENT TRANSACTION AUTHENTICATION”, “MOBILE DEVICE EQUIPPED WITH A CONTACTLESS SMART CARD READER/WRITER”, and “MOBILE COMMUNICATION DEVICE EQUIPPED WITH A MAGNETIC STRIPE READER”, respectively, the contents of which applications are expressly incorporated herein by reference.

### FIELD OF THE INVENTION

The present invention relates to a system and a method for mobile payment and fulfillment of digital goods, and more particularly to a mobile payment transaction and fulfillment of digital goods with a strong authentication.

### BACKGROUND OF THE INVENTION

Smart Cards used in the financial services industry are rapidly replacing magnetic stripe cards. The primary reason for the migration to smart cards is the increased level of security that smart cards can provide. Smart Cards have an embedded Integrated Circuit (IC) that enables a highly secure computing environment to store sensitive information, such as credit card information, medical information, digital certificates and biometric data. Smart Cards are also used as a secure repository for “digital goods”, such as electronic cash (e-Cash), electronic tickets (e-Tickets), electronic coupons (e-Coupons), loyalty points (i.e. frequent flyer miles, frequent shopper points), credits for pre-paid mobile airtime, credits for pre-paid utilities, and digital rights management (DRM) certificates for accessing multi-media applications. The greatest use of these “e-Purses” on smart cards are e-Cash schemes from Visa International and MONDEX International and transit token systems that comply to the MIFARE (Philips) and Octopus (Sony). While the use of smart cards has been the catalyst for e-Purse business, the challenge is the expense in installing and maintaining the card reader/writer infrastructure required to enable users to “top up” or “reload” or “download” digital goods and monetary value to their smart cards. Typically, users can load/reload digital goods and value onto the card by using an Automated Teller Machine (ATM), a kiosk or a Point of Sale (POS) system in a store to transfer money from a checking account, savings account, a credit card account or by inserting cash into the ATM. These ATMs are typically located at the entrance to the transit stations, small merchant stores and bank outlets. The number and availability of the smart card reader/writer equipment determine the amount of usage of smart cards. There is a need for a secure, low cost system that can be used to fulfill and pay for digital goods.

### SUMMARY OF THE INVENTION

This invention features an electronic payment and digital good fulfillment system utilized by a customer to pay for the purchase of a good and/or a service with a physical or virtual payment instrument. The present invention provides consumers or merchants with the ability to download digital goods such as electronic cash (e-Cash), electronic coupons (e-Coupon), electronic tickets (e-Ticket), electronic transit tokens, credits for pre-paid mobile airtime, credits for pre-paid utilities, credits for other types of pre-paid accounts, a digital receipt or ticket that can be utilized at a later point to further receive digital goods (i.e., a Hidden Rechargeable Number “HRN” for pre-paid top up), digital rights management (DRM) certificates and digital media such as music, software, movies, books and other digital content to a smart card, contactless smart card or magnetic stripe card.

In general, in one aspect of this invention features an electronic payment and fulfillment system utilized by a customer for purchasing a digital good including a merchant server, a payment server, an authentication server, a communication device, and a fulfillment server. The merchant server is programmed to receive a purchase order from the customer for the purchase of the digital good, and to create a digital order comprising purchase order information. The payment server is programmed to receive the digital order from the merchant server and to further route the digital order. The authentication server is programmed to receive the digital order from the payment server, format the digital order into a first message and further route the first message. The communication device includes a payment card module and the payment card module is adapted to receive a payment card and read payment card identification information stored in the payment card. The communication device is also adapted to receive the first message from the authentication server, display the first message to the customer, request and receive authorization for payment for the purchase order with the payment card from the customer, retrieve the payment card identification information, request and receive payment card security information from the customer, and route the authorization and the payment card identification and security information to the authentication server. The authentication server further routes the authorization and payment card identification and security information to the payment server and from the payment server to a financial institution. The financial institution is asked to execute the payment and to send a payment confirmation through the payment server to the merchant server and to the authentication server. The fulfillment server is programmed to receive the payment confirmation from the payment server and transmit the digital good via the authentication server to the communication device. The communication device then stores the digital good onto the payment card.

Implementations of this aspect of the invention include the following. The communication device may be a wireless communication device or a wired communication device. The merchant server, the payment server, the authentication server, the fulfillment server and the communication device are adapted to send and receive messages among each other via a first network and the wireless communication device is adapted to send and receive messages to the authentication server via a second network and the second network may be a wireless network. The wireless communication device may be a mobile phone, a personal digital assistant, a pager, a wireless laptop computer, a personal computer, a television remote control, programmable versions thereof or combinations thereof. The wireless network may be a wireless wide area network (WWAN), a wireless local area network (WLAN), a personal area network (PAN) or a private communication network The wireless wide area network (WWAN) may be a Global System for Mobile Communications (GSM), General Packet Radio Service (GPRS), a Code Division Multiple Access (CDMA), CDMA 2000, or wideband CDMA (WCDMA). The wired communication device may be a telephone and the first network may be a telecommunications network. The wired communication device may be a computer and the first network may be the Internet. The payment card may be a smart card such as a full size smart card, a contactless smart card, a SIM smart card, a USIM smart card, a credit card, a debit card, a stored-value card, a coupon card, a reward card, an electronic cash card, a loyalty card, an identification card or combinations thereof. The payment card may be a magnetic stripe card. The merchant server may receive the purchase order from the customer via the Internet, telephone connection, mail order form, fax, e-mail, voice recognition system, shot message service, interactive voice recording (IVR), or face-to-face communication with the customer. The wireless communication device may have a subscriber identification module (SIM) card slot and the payment card module may be electrically connected to the SIM card slot. The payment card information may be cardholder identification information, card identification information, authentication information, card issuer information, or financial institution information. The digital good may be electronic cash, electronic tickets, electronic coupons, loyalty points, credits for pre-paid mobile airtime, credits for pre-paid utilities, electronic gift certificates, digital rights managements (DRM) certificates, electronic transit tokens, music, software, movies, or books. The merchant server and the fulfillment server may be one entity. The customer may place the purchase order to the merchant server via the communication device. The communication device may further include a shopping application and the customer may utilize the shopping application, to select the digital good, to place the purchase order, to authorize, authenticate and pay with the payment card, and to store the digital good onto the payment card. The payment card module may include a payment card reader and writer module. The communication device may further include a digital good generation application and the digital good generation application may receive a digital receipt for the digital good and generate the digital good. The first message may have a format such as Short Message Service (SMS), General Packet Radio Service (GPRS), Transmission Control Protocol/Internet Protocol (TCP/IP), User Datagram Protocol (UDP), Simple Mail Transmission Protocol (SMTP), Simple Network Management Protocol (SNMP), or proprietary message formats.

In general in another aspect the invention features an electronic payment and fulfillment method utilized by a customer for purchasing a digital good including placing a purchase order with a merchant server for the digital good and choosing to pay via a communication device. Next, providing the merchant server with identification information for the communication device and creating a digital order comprising purchase order information and the identification number for the communication device by the merchant server. Next, routing the digital order to a payment server and from the payment server to an authentication server. Next, formatting the digital order into a first message by the authentication server and routing the first message to the communication device. Next, displaying the first message on the communication device and requesting and receiving authorization of payment from the customer. Next, retrieving identification information of a payment card from the communication device and requesting and receiving security information of the payment card from the customer via the communication device. Next, routing the authorization and the payment card identification and security information through the authentication server to the payment server and from the payment server to a financial institution. Next, executing the payment at the financial institution and sending a payment confirmation to the payment server. Next, routing the payment confirmation from the payment server to the merchant server and to a fulfillment server and transmitting the digital good from the fulfillment server via the authentication server to the communication device. Finally, storing the digital good onto the payment card by the communication device.

Among the advantages of this invention may be one or more of the following. Combining a smart card reader (contact or contactless) with a mobile phone can dramatically increase the number of smart card reader points of sales in the marketplace to create more convenience for consumers and more opportunities for merchants. Consumers or merchants with a mobile phone equipped with a smart card reader would be able to load value to their cards (contact or contactless) anytime, anywhere. Using a secure, non-repudiatable payment enables the secure over-the-air download of digital goods. In countries or locations where a “land-line” telephone connection required by an Automated Teller Machine (ATM) or merchant Point of Sale (POS) system is either too expensive or not feasible, a mobile device equipped with a smart card reader is significantly more cost effective and convenient.

### BRIEF DESCRIPTION OF THE DRAWINGS

FIG. 1 is a schematic diagram of a system for digital goods purchase and fulfillment using a mobile device with a smart card reader according to this invention.

FIG. 2 illustrates prior art circuitry for the mobile device attachment that converts a Single-SIM GSM phone into a Dual-SIM/Dual-Slot GSM phone.

FIG. 3 illustrates circuitry for a mobile device attachment that converts a Single-SIM GSM phone into a Dual-SIM/Dual-Slot GSM phone with a contactless smart card reader/writer.

FIG. 4 is a diagram of a payment and digital goods fulfillment system according to this invention.

FIG. 4A is a diagram of another embodiment of a payment and digital goods fulfillment system according to this invention.

FIG. 4B is a diagram of another embodiment of a payment and digital goods fulfillment system according to this invention.

FIG. 4C is a diagram of another embodiment of a payment and digital goods fulfillment system according to this invention.

FIG. 5 illustrates circuitry for a mobile device attachment that converts a Single-SIM GSM phone into a Dual-SIM/Dual-Slot GSM phone with a magnetic stripe card reader/writer.

FIG. 6 is a flow diagram for a shopping application on a mobile device.

FIGS. 6A-6L illustrate an example user scenario for mobile payment and digital goods fulfillment.

### DETAILED DESCRIPTION OF THE INVENTION

The present invention provides a smart card payment and digital goods fulfillment system. The smart card has the ability to retain stored value or other types of information within the card. These “digital goods” are electronic, virtual information that represents value such as electronic cash (e-Cash), electronic coupons (e-Coupon), electronic tickets (e-Ticket), electronic transit tokens, credits for pre-paid mobile airtime, credits for pre-paid utilities, credits for other types of pre-paid accounts, a digital receipt or ticket that can be utilized at a later point to further receive digital goods (i.e., a Hidden Rechargeable Number “HRN” for pre-paid top up), digital rights management (DRM) certificates and digital media such as music, software, movies, books and other digital content. The payment transaction and digital goods fulfillment system allows the purchase of digital goods and reception and storage of the digital goods on a smart card.

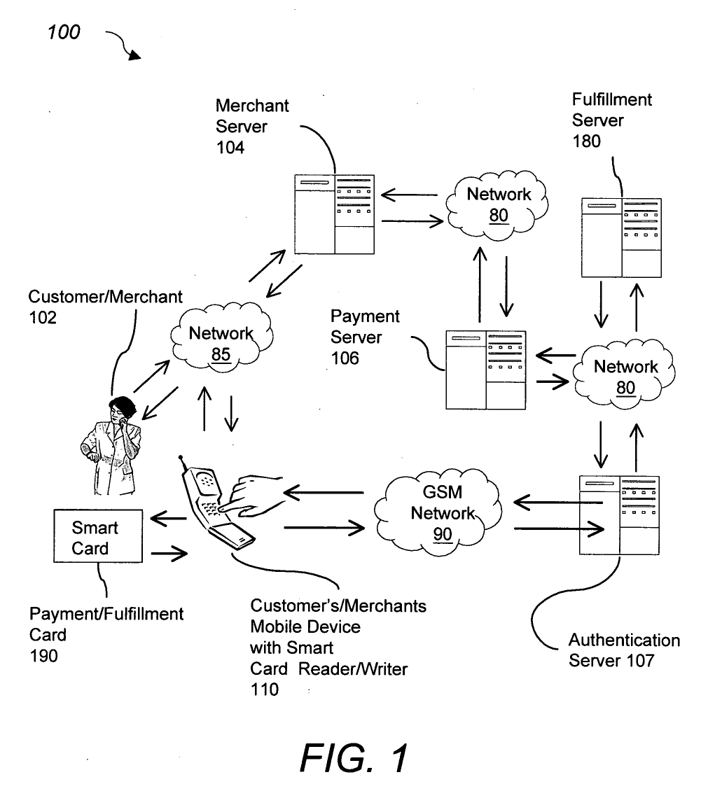

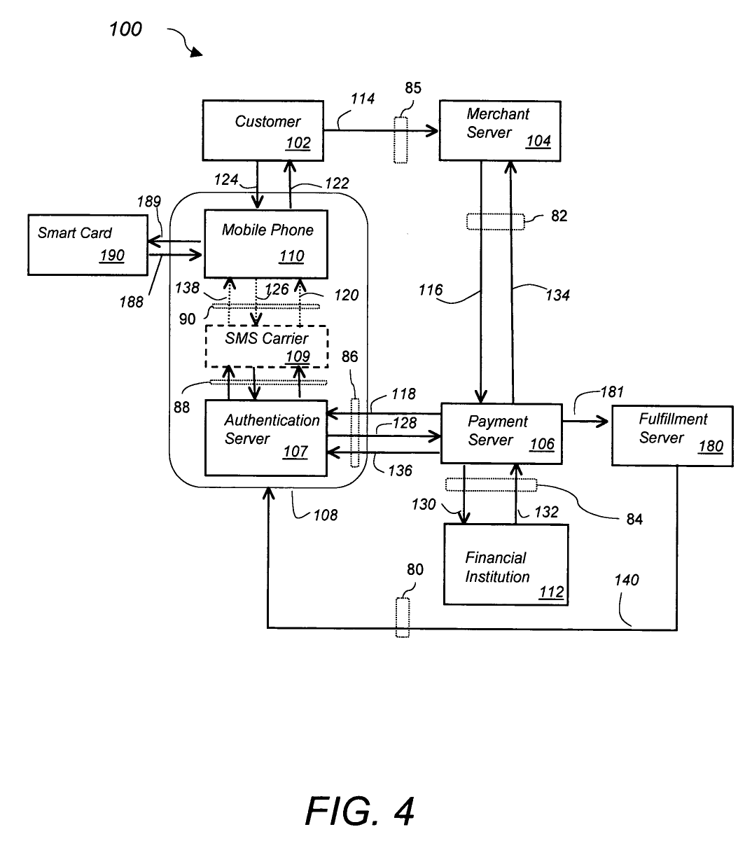

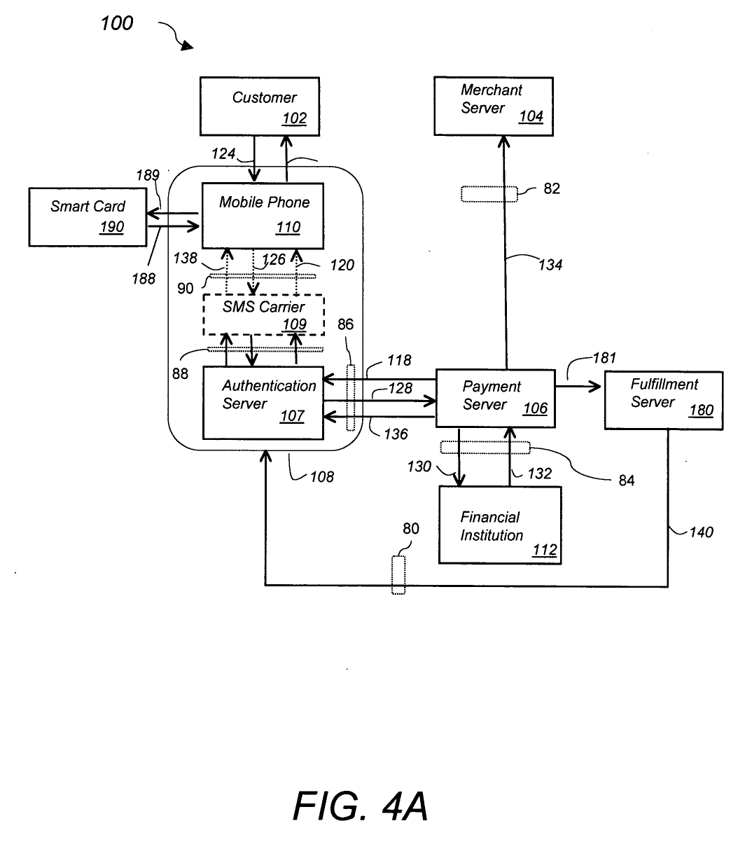

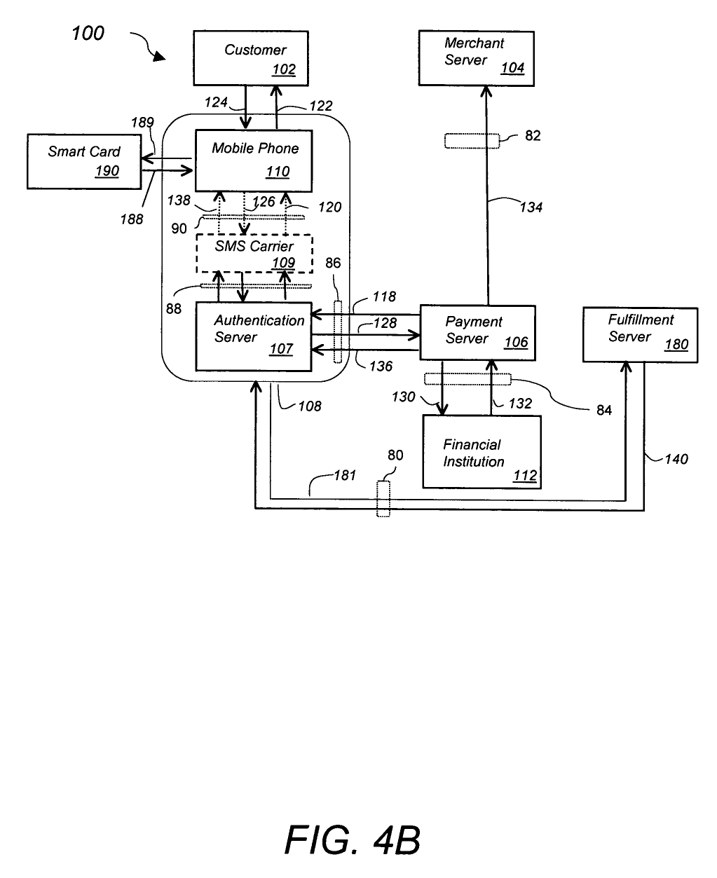

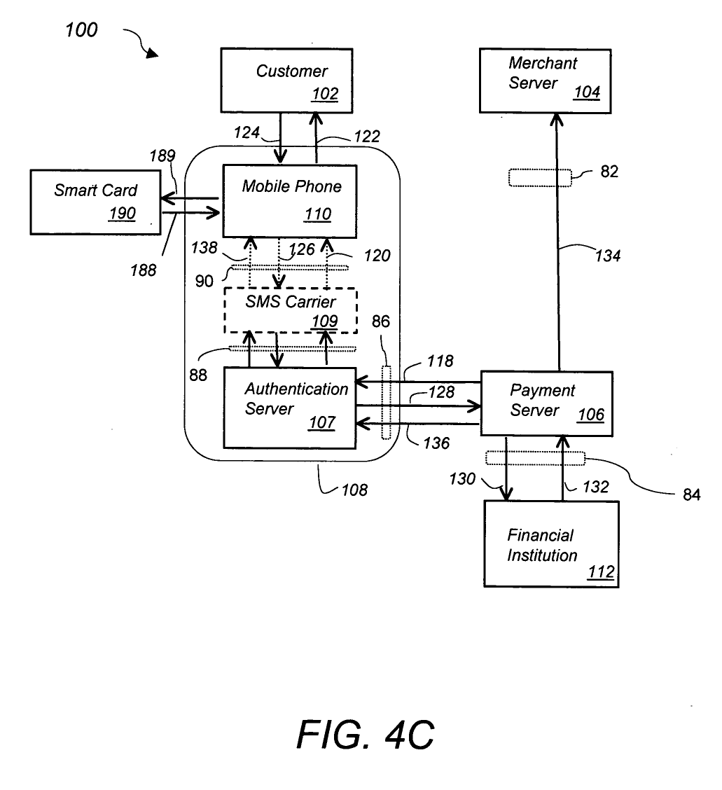

Referring to FIG. 1 and FIG. 4, a payment transaction and digital goods fulfillment system 100 includes a customer 102 with a smart card 190 and a mobile phone device 110 equipped with a smart card reader/writer, a merchant server 104, a payment server 106, an authentication system 108, a financial institution 112 and a fulfillment server 180. The authentication system 108 includes an authentication server 107 that is adapted to send and receive messages in a short message service (SMS) format to the mobile phone 110 via an SMS carrier 109. The mobile phone 110 is adapted to receive the payment card 190 or has a built-in payment card (not shown). After having placed an order for digital goods via the Internet, Short Message Service (SMS), Wireless Application protocol (WAP), or voice 85, customer 102 is asked to choose a payment method. The customer 102 chooses to pay via her mobile phone 110 and gives her mobile phone identification information to the merchant server 104 (114). In one example, the mobile phone identification information is the mobile phone number. The merchant server 104 routes the customer's mobile phone number and information about the purchase order to the payment server 106 (116). The payment server 106 contacts the authentication server 107 and routes the customer's mobile phone number and information about the purchase (118). The authentication server 107 sends an SMS message to the customer's mobile phone 110 through an SMS carrier 109 (120). The customer 102 receives the SMS message asking her to authorize the purchase and choose a payment card (122). The customer 102 authorizes the purchase, uses the smart card 190 that is associated with her mobile phone 110 (188) and enters a security code associated with the smart card to pay and authenticate her purchase (124). In one example, the security code is a personal identification number (PIN). Other examples include a password, digital signature, and a biometric identifier, i.e., retina scan, fingerprint, DNA scan, voice characteristics. The payment card 190 is identified with information that is embedded in the card. In one example the identification information is a payment card number. Other examples of payment card identification include an encrypted transaction signature that can only be decrypted by the financial institution that has issued the payment card, expiration date of the payment card, and a digital signature. The mobile phone 110 sends an SMS message via the SMS Carrier 109 to the authentication server 107. The SMS message includes the authorization result and payment transaction information (126). The authentication server 107 routes the authorized purchase order and authenticated card to the payment server 106 (128). The payment server 106 contacts the financial institution 112 that has issued the payment card and routes the payment card information and the purchase order information (130). The financial institution 112 processes the payment transaction and sends a confirmation of the payment transaction to the payment server 106 (132). The payment server 106 routes the payment confirmation to the merchant server 104 (134), presents a digital receipt to the fulfillment server 180 (181) and routes the payment confirmation to the authentication server 107 (136). The authentication server 107 sends an SMS message confirming the payment transaction to the customer's mobile phone 110 (138). Finally the fulfillment server 180 fulfills the customer's order for digital goods by sending the electronic information that represents the digital goods to the authentication server 107 (140). The authentication server 107 transfers the digital goods and sends an SMS message to the customer's mobile phone 110 through the SMS carrier 109 (120). The mobile phone 110 receives the digital goods from the authentication server 107 and the customer 102 receives a message that digital goods are available for the smart card. Finally, the digital goods are transferred from the mobile phone 110 to the smart card 190 (189).

The message routing 114 occurs over communication network 85, message routing 116, 134, occurs over communication network 82, message routing 118, 128, 136 occurs over communication network 86, message routing 120, 122, 124, 126, 138, occurs over communication network 90, and message routing 130, 132, occurs over communication network 84. Communication between the authentication server 107 and the SMS carrier 109 occurs over network 88, and communication between the fulfillment server 180 and the authentication server 107 is over network 80. In one example, communication networks 80, 82, 84, 85, 86, and 88 are the Internet and communication network 90 is a wireless network. In another example communication network 85 is wireless or wire line, voice or data network. The wireless network 85 and 90 may be a Wireless Wide Area Network (WWAN) (i.e., GSM, TDMA, CDMA, 3G, iDEN, Mobitex, and DataTac), a Wireless Local. Area Network (WLAN) (i.e., 802.11a, 802.11b), or a Personal Area Network (PAN) (i.e., Bluetooth, Infrared). Other examples of communication networks 80, 82, 84, 85, 86, 88 and 90 include private voice and data networks, and public voice and data networks. Message routing 114-140 is encrypted.

In the embodiments of FIG. 1 and FIG. 4, the fulfillment server 180 and the merchant server 104 are two separate entities. For example, the merchant server 104 contains the merchant catalog of music or documents that can be downloaded and the fulfillment server 180 is the storage repository for the actual digital media. In another embodiment the fulfillment server 180 and the merchant server 104 are the same entity (not shown).

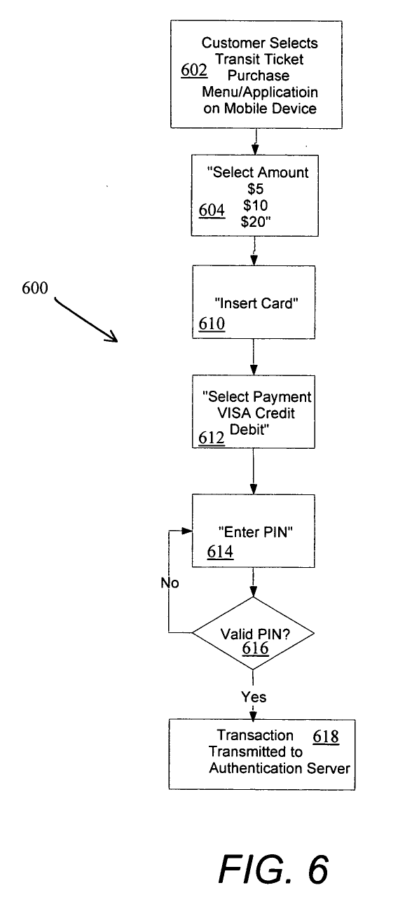

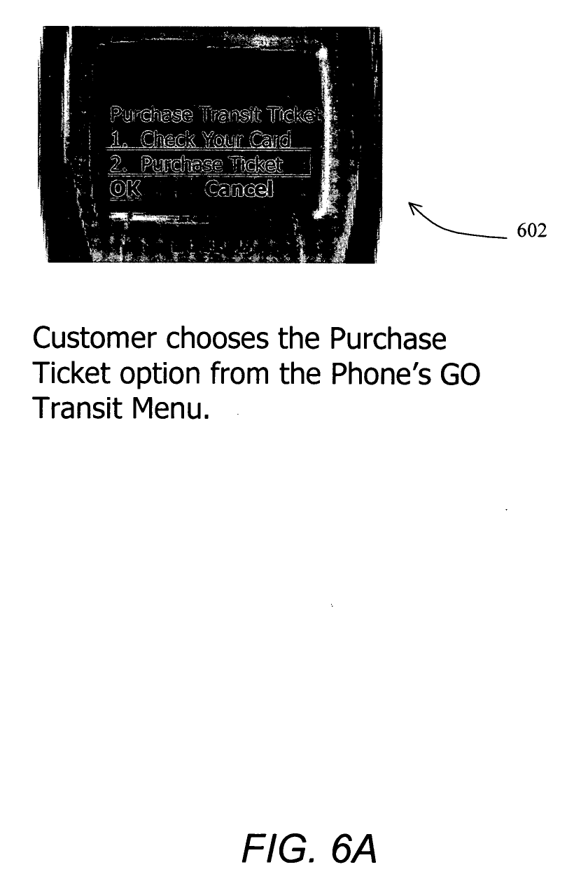

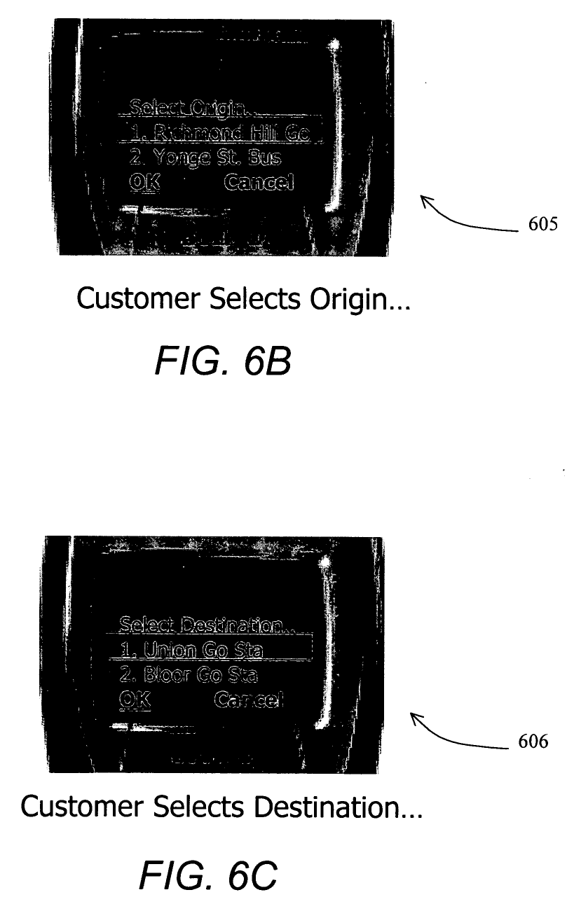

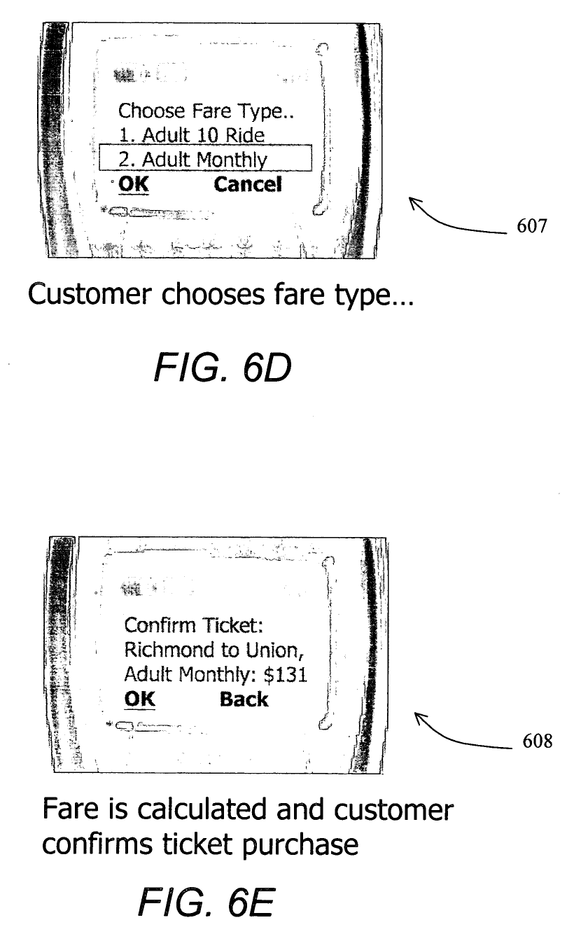

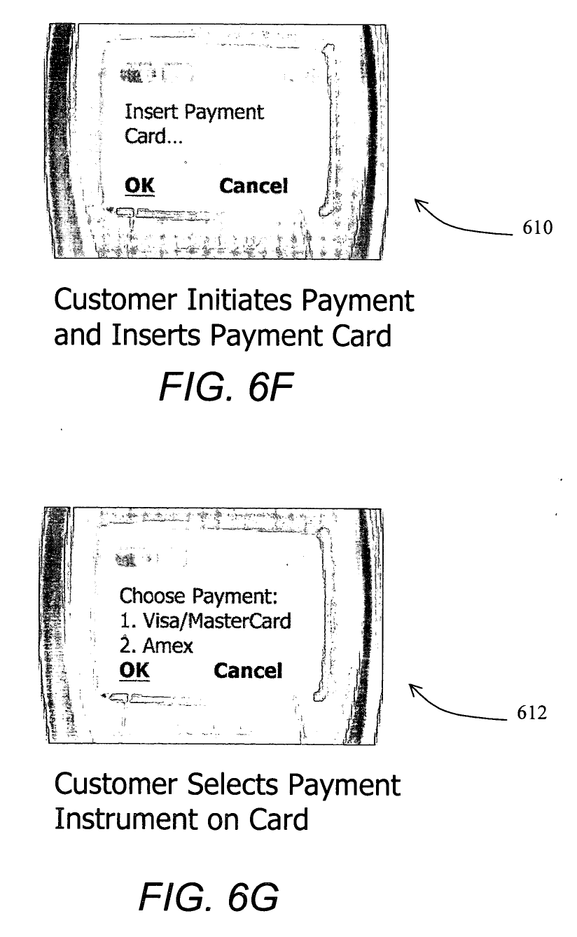

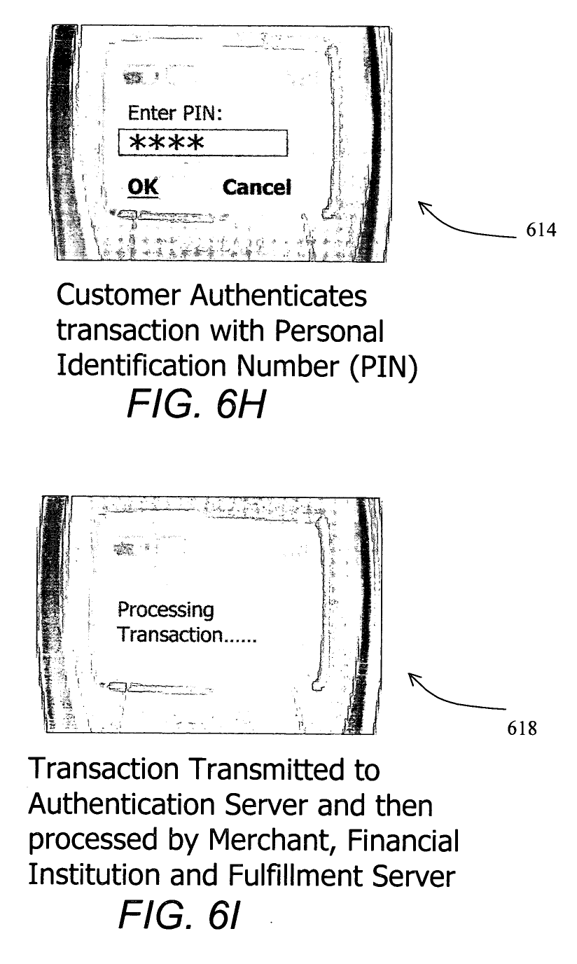

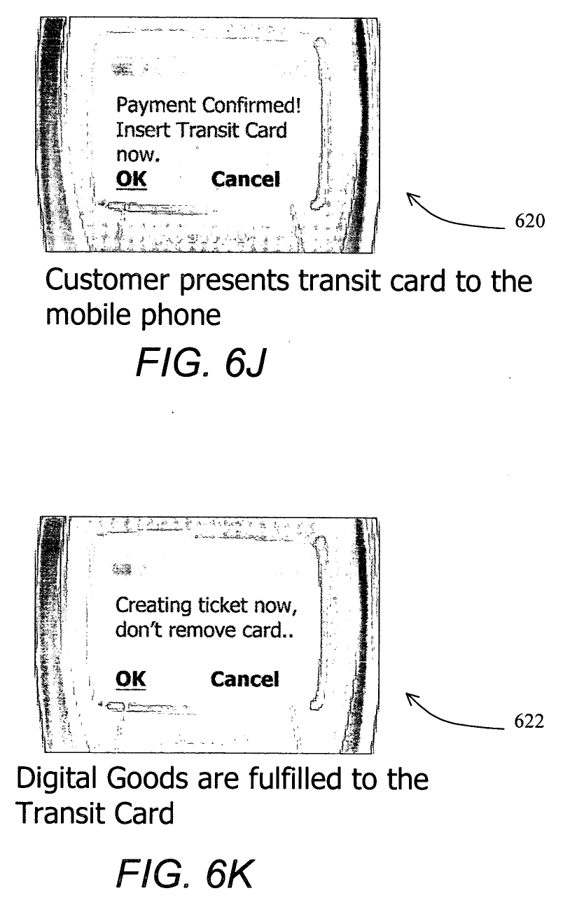

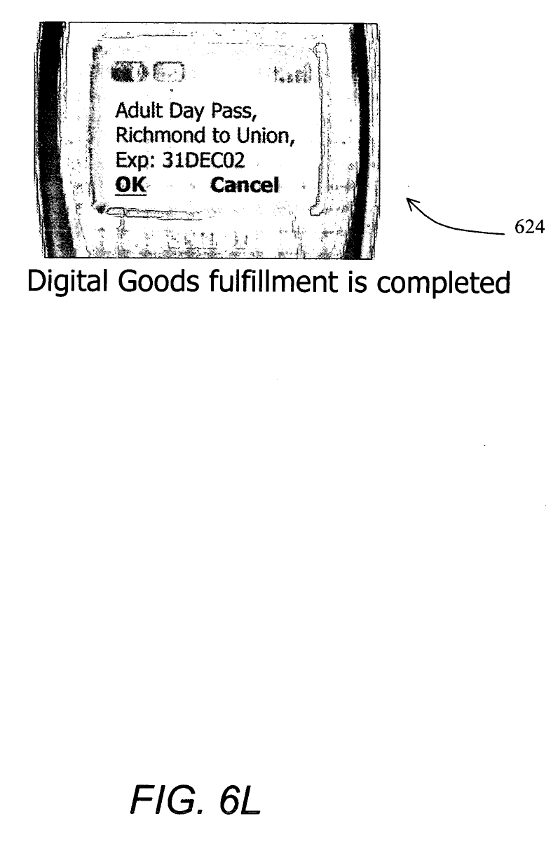

In the embodiment of FIG. 4A an order is initiated directly from the mobile phone device. The customer 102 interacts with a shopping application 600 on the mobile phone device 110 (shown in FIG. 6 and FIGS. 6A-6L) to initiate, place, authorize and fulfill an order.

Referring to FIG. 4A, the system for placing an order directly from the mobile phone device includes a customer 102 with a smart card 190 and a mobile phone device 110 equipped with smart card reader/writer, a merchant server 104, a payment server 106, an authentication system 108, a financial institution 112 and a fulfillment server 180. The authentication system 108 includes an authentication server 107 that is adapted to send and receive messages in a short message service (SMS) format to mobile phone 110 via an SMS carrier 109. The mobile phone 110 is adapted to receive the payment card 190 or has a built-in payment card (not shown). The customer 102 makes the purchase selection on the mobile device using a shopping application 600 and is prompted to authorize the purchase and choose a payment card (122). The customer 102 authorizes the purchase, uses a smart card 190 that is associated with her mobile phone 110 (188) and enters a security code associated with the smart card to pay and authenticate her purchase (124). The mobile phone 110 sends an SMS message via the SMS Carrier 109 to the authentication server 107(126). The SMS message includes the order details, merchant information, authorization result, and payment transaction information. The authentication server 107 routes the authorized purchase order and authenticated card to the payment server 106 (128). The payment server 106 contacts the financial institution 112 that has issued the payment card and routes the payment card information and the order information (130). The financial institution 112 processes the payment transaction and sends a confirmation of the payment transaction to the payment server 106 (132).

The payment server 106 routes the payment confirmation to the merchant server 104 (134), presents a digital receipt to the fulfillment server 180 (181) and routes the payment confirmation to the authentication server 107 (136). The authentication server 107 sends an SMS message confirming the payment transaction to the customer's mobile phone 110 (138). Finally the fulfillment server 180 fulfills the customer's order for digital goods by sending the electronic information that represents the digital goods to the authentication server 107 (140). The authentication server 107 transfers the digital goods and sends an SMS message to the customer's mobile phone 110 through the SMS carrier 109 (120). The mobile phone 110 receives the digital goods from the authentication server 107 and the customer 102 receives a message that digital goods are available for the smart card and the digital goods are transferred to the smart card 190 (189).

In one example the mobile phone device 110 is a programmable device, such as a Personal Digital Assistance (PDA)-type phone and the shopping application 600 is a series of menus on the mobile phone device that guide the customer through the shopping process. In another example, the mobile phone device 110 is a non-programmable phone and the shopping application 600 is an application that is installed on the mobile phone and accessed via the phone's interface. Referring to FIG. 6 and FIG. 6A to FIG. 6L, the shopping application 600 includes the following operations. The customer 102 selects a transit ticket purchase application on her PDA-type phone (602). Next, the customer 102 selects the desired fare amount (604). Alternatively, the customer 102 selects the origin station (605), the destination station (606), the fare type (607), and the fare is calculated by the application (608). Next, the customer 102 initiates the payment transaction and inserts a payment card (610). Next, the customer 102 selects the payment instrument on the card (i.e., VISA, Master Card, Amex) (612), and authenticates the payment transaction with her PIN number (614). If her PIN number is valid (616) the transaction is transmitted to the authentication server 107 and processed by the payment server 106, merchant server 104, financial institution 112, and fulfillment server 180 (618). When the payment is confirmed and the desired fare amount is ready to be transferred to the transit card, the application 600 prompts the customer 102 to insert her transit card in the phone card reader (620). Finally, the desired fare amount is transferred to the transit card (622) and the transaction is completed (624).

Referring to FIG. 4B, in another embodiment, the authentication server 107 presents the digital receipt to the fulfillment server. Following the payment authorization from the financial institution 112 a confirmation of the payment transaction is transmitted to the payment server 106 (132). The payment server 106 routes the payment confirmation to the merchant server 104 (134) and routes the payment confirmation to the authentication server 107 (136). The authentication server 107 sends an SMS message confirming the payment transaction to the customer's mobile phone 110 (138) and then presents a digital receipt to the fulfillment server 180 (181). The fulfillment server 180 fulfills the customer's order for digital goods by sending the electronic information that represents the digital goods to the authentication server 107 (140). The authentication server 107 transfers the digital goods and sends an SMS message to the customer's mobile phone 110 through the SMS carrier 109 (120). The mobile phone 110 receives the digital goods from the authentication server 107 and the customer 102 receives a message that digital goods are available for the smart card and the digital goods are transferred to the smart card 190 (189).

Referring to FIG. 4C, in another embodiment, the mobile phone device receives a digital receipt that is then transmitted to the smart card, and is then utilized by an application on the smart card such as a transit token or e-Cash application as the authorization to generate digital goods. Following the payment authorization from the financial institution 112 a confirmation of the payment transaction is transmitted to the payment server 106 (132). The payment server 106 routes the payment confirmation to the merchant server 104 (134) and routes the payment confirmation to the authentication server 107 (136). The authentication server 107 sends a digital receipt 110 and an SMS message confirming the payment transaction to the customer's mobile phone (138). The mobile phone 110 receives the confirmation message and the digital receipt for digital goods from the authentication server 107 and the customer 102 receives a message that digital goods are available. An application on the smart card or on the mobile phone generates the digital goods based on the information contained within the digital receipt. The digital goods are created and transferred to the smart card 190 (189).

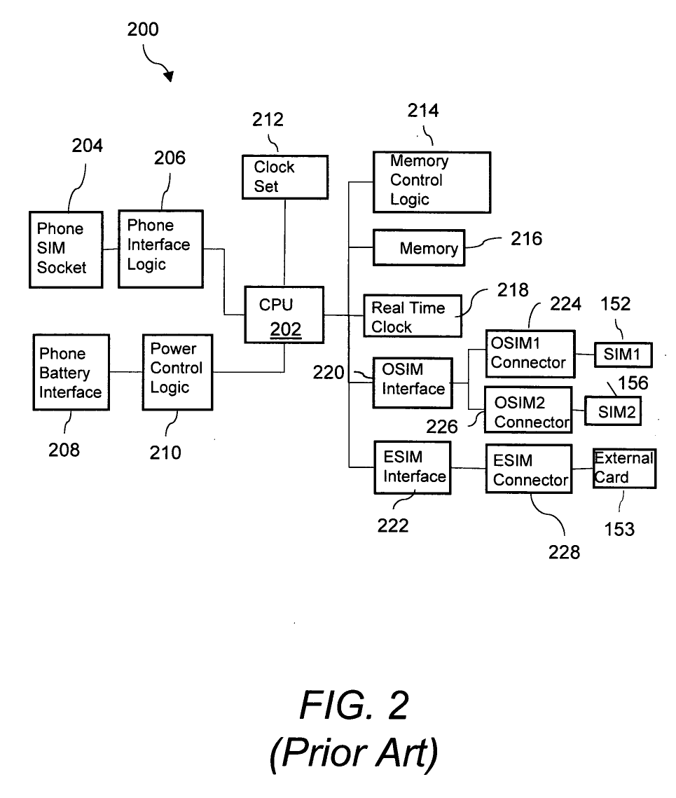

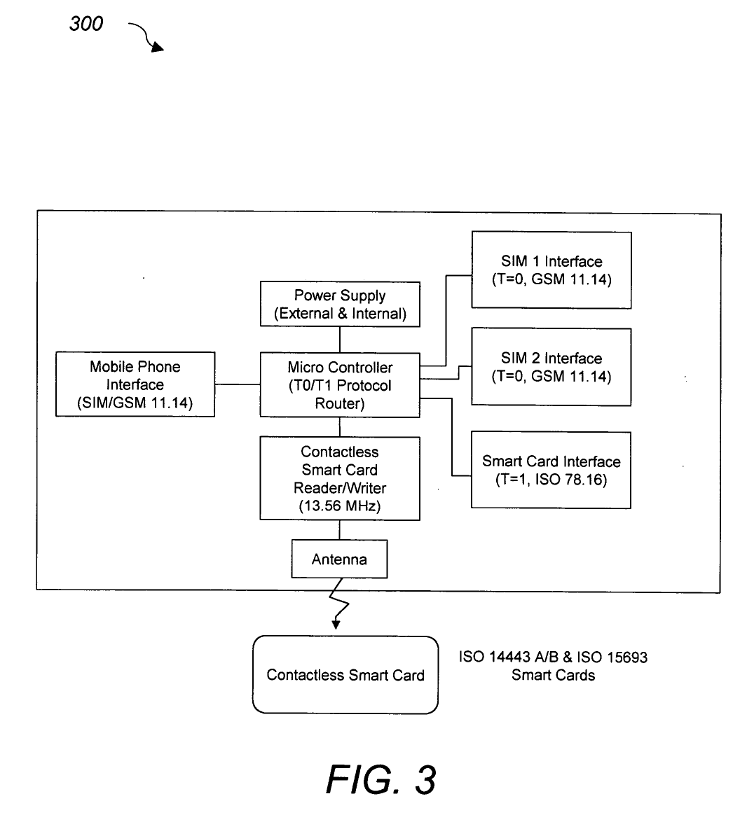

In another embodiment, the payment authentication instrument may be contained on one or many Subscriber Identity Module (SIM) smart cards for GSM wireless networks or Universal Subscriber Identity Module (USIM) smart cards for 3G wireless networks within the mobile phone 110, or within full-size smart cards inserted into a smart card reader 153 that is either attached to or embedded in the mobile phone device 110 or contained on a contactless smart card that can be accessed by a mobile phone device 110 with a contactless reader. The general concept of connecting additional smart card readers by implementing a connection to the existing SIM connector on a mobile phone is defined in the prior art “Communication Method and Apparatus Improvements” (PCT International Publication Number WO 99/66752), the entire content of which is incorporated herein by reference. This prior art defines the implementation of a mobile phone device attachment 200 that utilizes a Central Processor Unit to coordinate the activities of multiple SIM cards and full-size smart cards (See FIG. 2). The prior art defines the basic design of a mobile phone that provides a smart card reader either attached to the phone as an accessory or embedded into the design of the phone. Co-pending patent application entitled “Mobile Device Equipped with a Contactless Smart Card Reader”, the entire content of which is incorporated herein by reference, describes a mobile phone that provides a “contactless” smart card reader 300 to read/write data to a contactless smart card (see FIG. 3).

In another embodiment, the receiver of the digital goods can be one or many Subscriber Identity Module (SIM) smart cards for GSM wireless networks or Universal Subscriber Identity Module (USIM) smart cards for 3G wireless networks within the mobile phone 110, or a full-size smart cards inserted into a smart card reader that is either attached to or embedded in the mobile phone device 110 or a contactless smart card that can be accessed by a mobile device 110 with a contactless reader or the mobile phone itself.

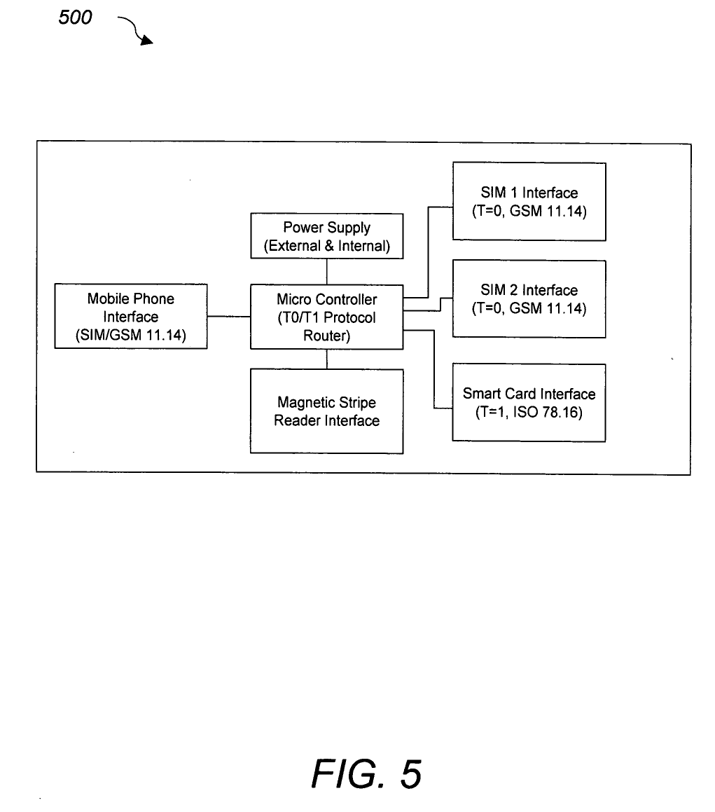

In another embodiment, the payment authentication card can be a magnetic stripe payment card that is accessed by the mobile phone device utilizing the magnetic stripe card reader 500 described in a co-pending patent application entitled “Mobile Communication Device Equipped with a Magnetic Stripe Reader”, the entire content of which is incorporated herein by reference, (see FIG. 5).

Other embodiments are within the scope of the following claims. For example, the smart card reader and/or payment card reader is adapted to connect to the mobile phone device through the mobile phone device's accessory connection point such as serial, USB, Compact Flash, Infrared, Bluetooth and Secure Digital. The digital goods may be fulfilled to a dual-interface contact/contactless smart card, or to a multi application “combi” contact/contactless smart card. The authentication of the customers Personal Identification Number (PIN) may be processed online at the financial institution or with a third-party server-side wallet account. The payment instrument may an account established with a server-side wallet. A browser on the mobile device may be utilized for entering the payment information. The payment information may be verbally transcribed to a customer service representative or a speech recognition system. The payment information may also be transcribed utilizing an Interactive Voice Response system. The digital goods are transferred to a customer's virtual or server-side account. The digital goods that are downloaded may be a digital receipt for goods to be fulfilled at a later time by the customer such as the online generation of a Hidden Rechargeable Number (HRN) for pre-paid top up that the customer will utilize to top up a pre-paid mobile, utility or other type of pre-paid account. The mobile device may be held by a merchant to accept payment from and fulfill digital goods to a plurality of customers. In addition to SMS messaging via the SMS Carrier 109 between the authentication server 107 and the mobile phone 110, the communication between the authentication server 107 and the mobile phone 110 may be via a proprietary message protocol that utilizes User Datagram Protocol (UDP) on top of Internet Protocol (IP). This proprietary message protocol is adapted to be used with wireless networks that support Transmission Control Protocol/Internet Protocol (TCP/IP). These wireless networks include Bluetooth, 3G, GPRS, 2.5G, Infrared, WCDMA, CDMA200, 802.11a and 802.11b. The mobile phone identification information may be an Internet Protocol (IP) address. The communication networks 80, 82, 84, 86, 88 and 90 may be wireless or wired networks. The communication networks 80, 82, 84, 86, 88 and 90 may be non face-to-face via the Internet, VPN (Virtual Private Network), cable network, data network, telephone network, private voice and data networks, public voice and data networks, and mail or person to person. Payment card identification may occur via the payment card number or via an encrypted transaction signature that can only be decrypted by the financial institution that has issued the payment card. The authentication server may also utilize a password, digital signature, or a biometric identifier, i.e., retina scan, fingerprint, voice characteristics, to authenticate the payment transaction. The payment authentication instrument may be contained in the contactless smart card, on the SIM smart cards within the mobile phone 110, or within another full-size smart card that needs to be inserted into a smart card reader slot. The communication mobile phone device may be a mobile wireless device and the second network may be a wireless network. The mobile wireless device may be a mobile phone, a personal digital assistant, a pager, a wireless laptop computer, a personal computer, a television remote control, or combinations thereof. The second network may be a wireless wide area network (WWAN), a wireless local area network (WLAN) or a wireless personal area network (PAN). The communication device may also be a wired communication device and the second network may be a wired network. The wired communication device may be a telephone or a computer and the wired network may be a telecommunications network or the Internet, respectively. The first network may be the Internet or a telecommunication network.

Several embodiments of the present invention have been described. Nevertheless, it will be understood that various modifications may be made without departing from the spirit and scope of the invention. Accordingly, other embodiments are within the scope of the following claims.

What is claimed is:

1. An electronic payment and fulfillment system utilized by a customer for purchasing a digital good comprising:
a merchant server adapted to receive a purchase order from said customer for the purchase of said digital good, and to create a digital order comprising purchase order information;
a payment server adapted to receive said digital order from said merchant server and to further route said digital order;
an authentication server adapted to receive said digital order from said payment server, format said digital order into a first message and further route said first message;
a communication device comprising a payment card module wherein said payment card module is adapted to receive a payment card and read payment card identification information stored in said payment card, and wherein said communication device is adapted to receive said first message from said authentication server, display said first message to said customer, request and receive authorization for payment for said purchase order with said payment card from said customer, retrieve said payment card identification information, request and receive payment card security information from said customer, and route said authorization and said payment card identification and security information to the authentication server, and wherein said authentication server further routes said authorization and payment card identification and security information to said payment server and from said payment server to a financial institution, wherein said financial institution is asked to execute said payment and to send a payment confirmation through said payment server to said merchant server and to said authentication server; and
a fulfillment server adapted to receive said payment confirmation from said payment server and transmit said digital good via said authentication server to said communication device, wherein said communication device stores said digital good onto said payment card.

2. The system of claim 1 wherein said communication device comprises a wireless communication device.

3. The system of claim 1 wherein said communication device comprises a wired communication device.

4. The system of claim 3 wherein said merchant server, said payment server, said authentication server, said fulfillment server and said communication device are adapted to send and receive messages among each other via a first network.

5. The system of claim 2 wherein said merchant server, said payment server, said authentication server, and said fulfillment server are adapted to send and receive messages among each other via a first network and said wireless communication device is adapted to send and receive messages to said authentication server via a second network and wherein said second network comprises a wireless network.

6. The system of claim 2 wherein said wireless communication device is selected from a group consisting of a mobile phone, a personal digital assistant, a pager, a wireless laptop computer, a personal computer, a television remote control, programmable versions thereof and combinations thereof.

7. The system of claim 5 wherein said wireless network is selected from a group consisting of a wireless wide area network (WWAN), a wireless local area network (WLAN), a personal area network (PAN) and a private communication network.

8. The system of claim 7 wherein said wireless wide area network (WWAN) is selected from a group consisting of a Global System for Mobile Communications(GSM), General Packet Radio Service (GPRS), a Code Division Multiple Access(CDMA), CDMA 2000, and wideband CDMA(WCDMA).

9. The system of claim 4 wherein said wired communication device comprises a telephone and said first network comprises a telecommunications network.

10. The system of claim 4 wherein said wired communication device comprises a computer and said first network comprises the Internet.

11. The system of claim 1 wherein said payment card comprises a smart card selected from a group consisting of a full size smart card, a contactless smart card, a SIM smart card, a USIM smart card, a credit card, a debit card, a stored-value card, a coupon card, a reward card, an electronic cash card, a loyalty card, an identification card and combinations thereof.

12. The system of claim 1 wherein said payment card comprises a magnetic stripe card.

13. The system of claim 1 wherein said merchant server receives said purchase order by said customer via a route selected from a group consisting of the Internet, telephone connection, mail order form, fax, e-mail, voice recognition system, shot message service, interactive voice recording (IVR), and face-to-face communication with the customer.

14. The system of claim 2 wherein said wireless communication device comprises a subscriber identification module (SIM) card slot and said payment card module is electrically connected to said SIM card slot.

15. The system of claim 1 wherein said payment card information is selected from a group consisting of cardholder identification information, card identification information, authentication information, card issuer information, and financial institution information.

16. The system of claim 1 wherein said digital good is selected from a group consisting of electronic cash, electronic tickets, electronic coupons, loyalty points, credits for pre-paid mobile airtime, credits for pre-paid utilities, electronic gift certificates, digital rights managements(DRM) certificates, electronic transit tokens, music, software, movies, and books.

17. The system of claim 1 wherein said merchant server and said fulfillment server comprise one entity.

18. The system of claim 1 wherein said customer places said purchase order to said merchant server via said communication device.

19. The system of claim 1 wherein said communication device further comprises a shopping application and wherein said customer utilizes said shopping application, to select said digital good, to place said purchase order, to authorize, authenticate and pay with said payment card, and to store said digital good onto said payment card.

20. The system of claim 1 wherein said payment card module comprises a payment card reader and writer module.

21. The system of claim 1 wherein said communication device further comprises a digital good generation application and wherein said digital good generation application receives a digital receipt for said digital good and generates said digital good.

22. The system of claim 1 wherein said first message comprises a format selected from a group consisting of Short Message Service (SMS), General Packet Radio Service (GPRS), Transmission Control Protocol/Internet Protocol (TCP/IP), User Datagram Protocol (UDP), Simple Mail Transmission Protocol (SMTP), Simple Network Management Protocol (SNMP), and proprietary message formats.

23. An electronic payment and fulfillment method utilized by a customer for purchasing a digital good comprising:
placing a purchase order with a merchant server for said digital good and choosing to pay via a communication device;
providing said merchant server with identification information for said communication device;
creating a digital order comprising purchase order information and said identification number for said communication device by said merchant server;
routing said digital order to a payment server and from said payment server to an authentication server;
formatting said digital order into a first message by said authentication server and routing said first message to said communication device;
displaying said first message on said communication device and requesting and receiving authorization of payment from the customer;
retrieving identification information of a payment card from said communication device;
requesting and receiving security information of said payment card from said customer via said communication device;
routing said authorization and said payment card identification and security information through said authentication server to said payment server and from said payment server to a financial institution;
executing said payment at said financial institution and sending a payment confirmation to said payment server;
routing said payment confirmation from said payment server to said merchant server and to a fulfillment server;
transmitting said digital good from said fulfillment server via said authentication server to said communication device; and
storing said digital good onto said payment card by said communication device.

24. The method of claim 23 wherein said communication device comprises a payment card module adapted to receive said payment card and read said payment card identification information stored in said payment card and to receive a digital good and store said digital good onto said payment card.

25. The method of claim 23 wherein said communication device comprises a wireless communication device.

26. The method of claim 23 wherein said communication device comprises a wired communication device.

27. The method of claim 26 wherein said merchant server, said payment server, said authentication server, said fulfillment server and said communication device are adapted to send and receive messages among each other via a first network.

28. The method of claim 25 wherein said merchant server, said payment server, said authentication server, and said fulfillment server are adapted to send and receive messages among each other via a first network and said wireless communication device is adapted to send and receive messages to said authentication server via a second network and wherein said second network comprises a wireless network.

29. The method of claim 25 wherein said wireless communication device is selected from a group consisting of a mobile phone, a personal digital assistant, a pager, a wireless laptop computer, a personal computer, a television remote control, programmable versions thereof and combinations thereof.

30. The method of claim 28 wherein said wireless network is selected from a group consisting of a wireless wide area network (WWAN), a wireless local area network (WLAN), a personal area network (PAN) and a private communication network.

31. The method of claim 30 wherein said wireless wide area network (WWAN) is selected from a group consisting of a Global System for Mobile Communications(GSM), General Packet Radio Service (GPRS), a Code Division Multiple Access(CDMA), CDMA 2000, and wideband CDMA(WCDMA).

32. The method of claim 26 wherein said wired device comprises a telephone and said first network comprises a telecommunications network.

33. The method of claim 26 wherein said wired device comprises a computer and said first network comprises the Internet.

34. The method of claim 23 wherein said payment card comprises a smart card selected from a group consisting of a full size smart card, a contactless smart card, a SIM smart card, a USIM smart card, a credit card, a debit card, a stored-value card, a coupon card, a reward card, an electronic cash card, a loyalty card, an identification card and combinations thereof.

35. The method of claim 23 wherein said payment card comprises a magnetic stripe card.

36. The method of claim 23 wherein said placing a purchase order comprises placing a purchase order via a route selected from a group consisting of the Internet, telephone connection, mail order form, fax, e-mail, voice recognition system, shot message service, interactive voice recording (IVR), and face-to-face communication with the customer.

37. The method of claim 24 wherein said communication device comprises a subscriber identification module (SIM) card slot and said payment card module is electrically connected to said SIM card slot.

38. The method of claim 23 wherein said payment card information is selected from a group consisting of cardholder identification information, card identification information, authentication information, card issuer information, and financial institution information.

39. The method of claim 23 wherein said digital good is selected from a group consisting of electronic cash, electronic tickets, electronic coupons, loyalty points, credits for pre-paid mobile airtime, credits for pre-paid utilities, electronic gift certificates, digital rights managements(DRM) certificates, electronic transit tokens, music, software, movies, and books.

40. The method of claim 23 wherein said merchant server and said fulfillment server comprise one entity.

41. The method of claim 23 wherein said customer places said purchase order to said merchant server via said communication device.

42. The method of claim 23 wherein said communication device further comprises a shopping application and wherein said customer utilizes said shopping application, to select said digital good, to place said purchase order, to authorize, authenticate and pay with said payment card, and to store said digital good onto said payment card.

43. The method of claim 24 wherein said payment card module comprises a payment card reader and writer module.

44. The method of claim 23 wherein said communication device further comprises a digital good generation application and wherein said digital good generation application receives a digital receipt for said digital good and generates said digital good.

45. The method of claim 23 wherein said first message comprises a format selected from a group consisting of Short Message Service (SMS), General Packet Radio Service (GPRS), Transmission Control Protocol/Internet Protocol (TCP/IP), User Datagram Protocol (UDP), Simple Mail Transmission Protocol (SMTP), Simple Network Management Protocol (SNMP), and proprietary message formats.
